(19) United States
(12) Patent Application Publication
(10) Pub. No.: US 2022/0312230 A1
(43) Pub. Date: Sep. 29, 2022

(54) EVENT TRIGGERED MEASUREMENT LOGGING

(71) Applicant: QUALCOMM Incorporated, San Diego, CA (US)

(72) Inventors: Rajeev KUMAR, San Diego, CA (US); Masato KITAZOE, Tokyo (JP); Shankar KRISHNAN, San Diego, CA (US); Xipeng ZHU, San Diego, CA (US); Umesh PHUYAL, San Diego, CA (US); Ozcan OZTURK, San Diego, CA (US); Gavin Bernard HORN, La Jolla, CA (US)

(21) Appl. No.: 17/652,897

(22) Filed: Feb. 28, 2022

Related U.S. Application Data
(60) Provisional application No. 63/164,941, filed on Mar. 23, 2021.

(51) Int. Cl. H04W 24/02; H04W 24/10

(52) U.S. Cl. CPC H04W 24/02; H04W 24/10

(57) ABSTRACT

Various aspects of the present disclosure generally relate to wireless communication. In some aspects, a user equipment (UE) may receive, from a network entity, a logged measurement configuration that defines an event for event triggered measurement logging, wherein the event is associated with a radio access technology (RAT)-specific coverage hole or a frequency specific coverage hole. The UE may perform, based at least in part on the logged measurement configuration, measurement logging based at least in part on an occurrence of the event associated with the RAT-specific coverage hole or the frequency specific coverage hole. Numerous other aspects are described.

### CROSS-REFERENCE TO RELATED APPLICATION

This patent application claims priority to U.S. Provisional Patent Application No. 63/164,941, filed on Mar. 23, 2021, entitled “EVENT TRIGGERED MEASUREMENT LOGGING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for event triggered measurement logging.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a network entity, a logged measurement configuration that defines an event for event triggered measurement logging, wherein the event is associated with a radio access technology (RAT)-specific coverage hole or a frequency specific coverage hole; and performing, based at least in part on the logged measurement configuration, measurement logging based at least in part on an occurrence of the event associated with the RAT-specific coverage hole or the frequency specific coverage hole.

In some aspects, a UE for wireless communication includes a memory and one or more processors, coupled to the memory, configured to: receive, from a network entity, a logged measurement configuration that defines an event for event triggered measurement logging, wherein the event is associated with a RAT-specific coverage hole or a frequency specific coverage hole; and perform, based at least in part on the logged measurement configuration, measurement logging based at least in part on an occurrence of the event associated with the RAT-specific coverage hole or the frequency specific coverage hole.

In some aspects, a non-transitory computer-readable medium storing a set of instructions for wireless communication includes one or more instructions that, when executed by one or more processors of a UE, cause the UE to: receive, from a network entity, a logged measurement configuration that defines an event for event triggered measurement logging, wherein the event is associated with a RAT-specific coverage hole or a frequency specific coverage hole; and perform, based at least in part on the logged measurement configuration, measurement logging based at least in part on an occurrence of the event associated with the RAT-specific coverage hole or the frequency specific coverage hole.

In some aspects, an apparatus for wireless communication includes means for receiving, from a network entity, a logged measurement configuration that defines an event for event triggered measurement logging, wherein the event is associated with a RAT-specific coverage hole or a frequency specific coverage hole; and means for performing, based at least in part on the logged measurement configuration, measurement logging based at least in part on an occurrence of the event associated with the RAT-specific coverage hole or the frequency specific coverage hole.

Aspects generally include a method, apparatus, system, computer program product, non-transitory computer-readable medium, user equipment, network entity, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3-9 are diagrams illustrating examples associated with event triggered measurement logging, in accordance with the present disclosure.

FIG. 10 is a diagram illustrating an example process associated with event triggered measurement logging, in accordance with the present disclosure.

FIG. 11 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

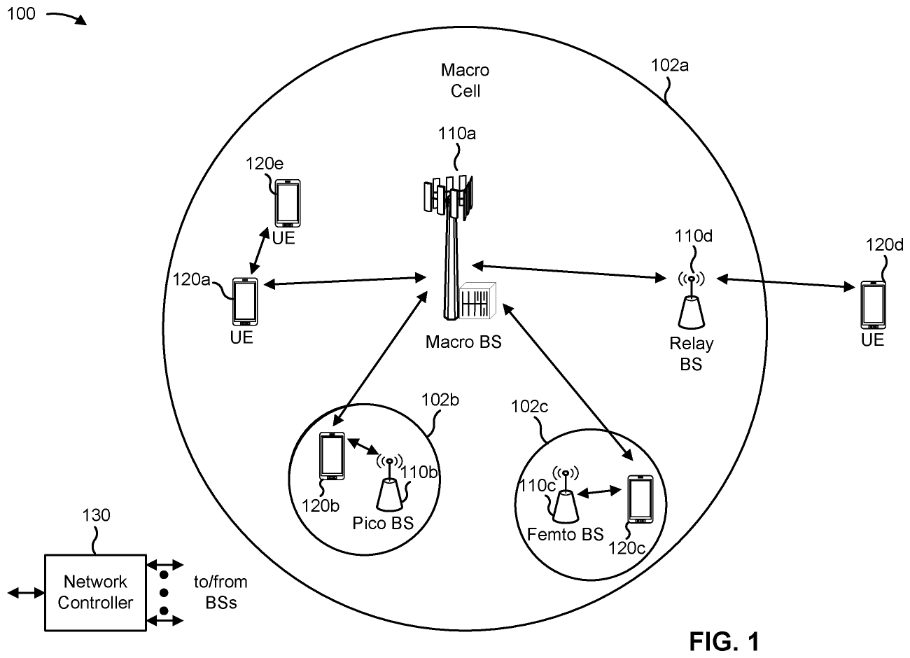

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As indicated above, FIG. 1 is provided as an example. Other examples may differ from what is described with regard to FIG. 1.

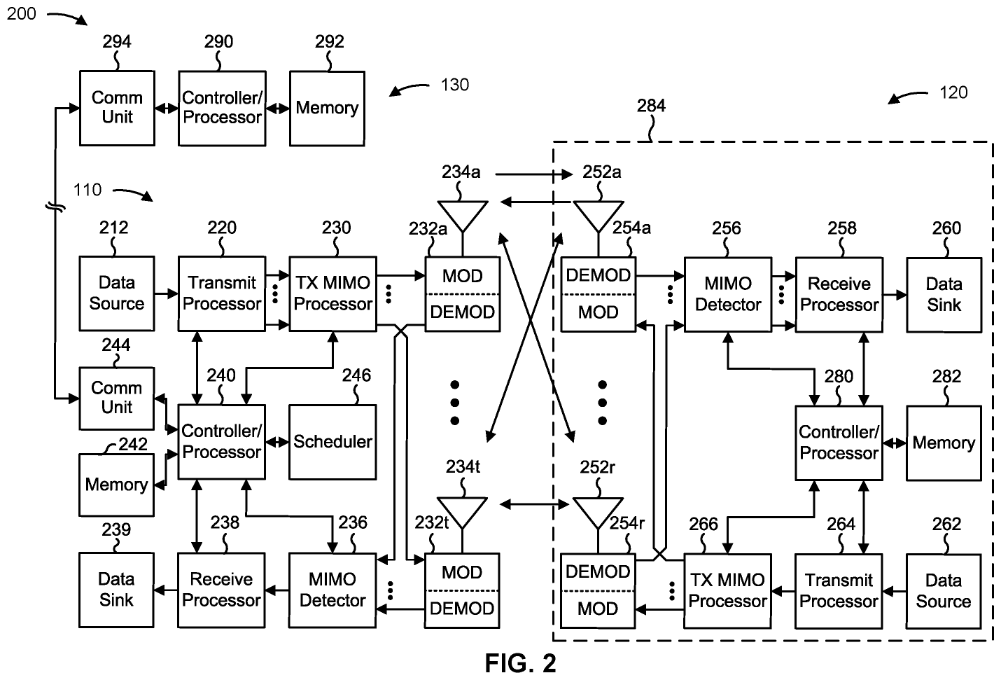

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

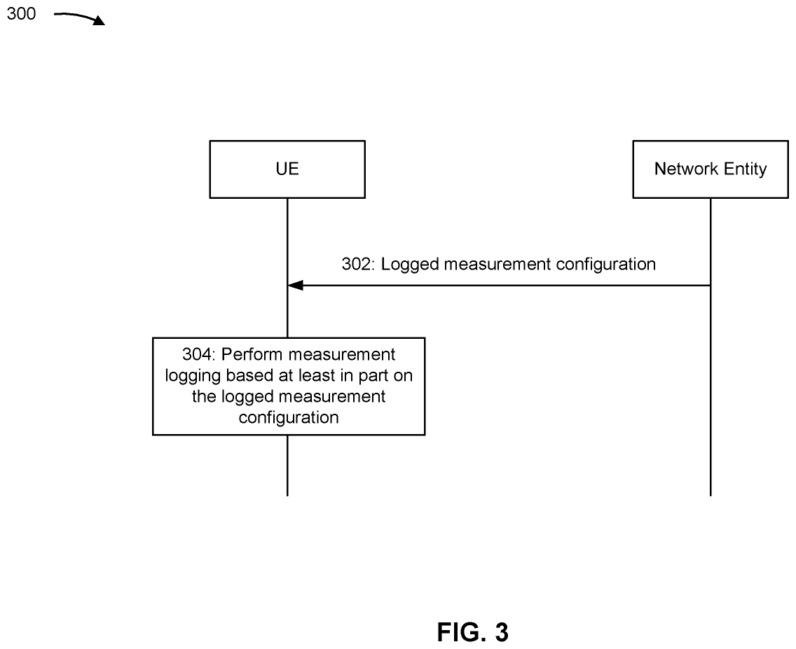

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-10).

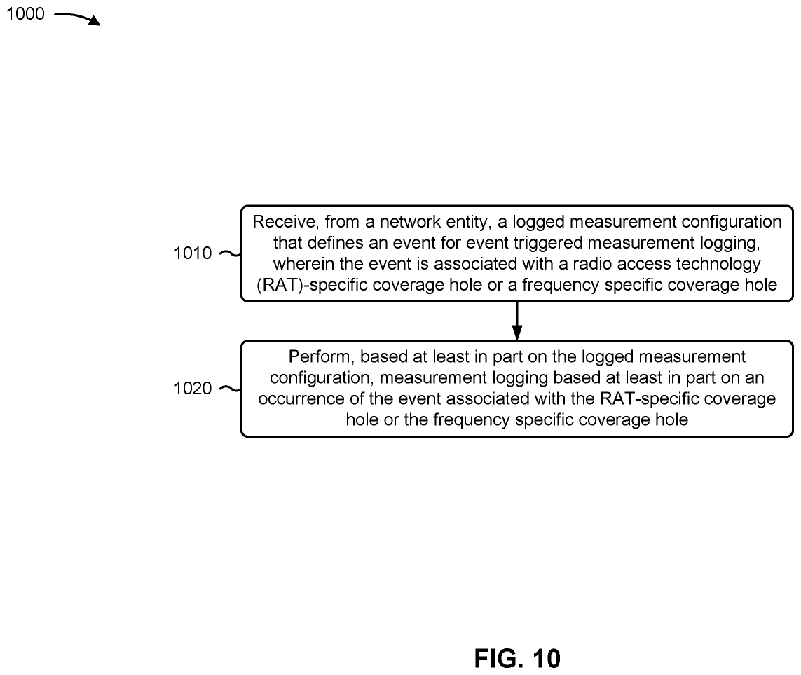

The controller/processor 240 of the base station 110, the controller/processor 280 of the UE 120, and/or any other component(s) of FIG. 2 may perform one or more techniques associated with event triggered measurement logging, as described in more detail elsewhere herein. For example, the controller/processor 240 of the base station 110, the controller/processor 280 of the UE 120, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network entity, a logged measurement configuration that defines an event for event triggered measurement logging, wherein the event is associated with a radio access technology (RAT)-specific coverage hole or a frequency specific coverage hole; and/or means for performing, based at least in part on the logged measurement configuration, measurement logging based at least in part on an occurrence of the event associated with the RAT-specific coverage hole or the frequency specific coverage hole. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Minimization of driving test (MDT) is a standardized mechanism to provide operators with network performance optimization tools in a cost-efficient manner. During a logged MDT procedure, a UE may perform logging of measurement results and report the logged measurement results to a network entity (e.g., a base station). The UE may log periodic measurements when the UE is camped on an NR cell.

For an event triggered measurement with an event set as “out of service” (OutofService), the UE may log a measurement when the UE is in an “any cell selection” (anyCellSelection) state. In other words, the UE may log the measurement when the UE cannot reselect to a cell (e.g., an NR cell or an LTE cell). The UE may go into the “any cell selection” state when the UE cannot camp to an NR cell or an LTE cell. The UE may perform periodic measurement logging after the UE is able to camp to an NR cell or an LTE cell.

For an event triggered measurement with an event set to a first event (eventL1), the UE may log a measurement when the first event occurs. The first event may occur when a camped cell radio quality does not satisfy a threshold (e.g., a camped cell radio quality goes below a threshold). In other words, the UE may perform the event triggered measurement when the camped cell radio quality does not satisfy a threshold. The UE may perform periodic measurement logging after the camped cell radio quality satisfies the threshold. For example, a camped cell radio quality associated with an NR cell on which the UE is camped on may become above the threshold.

Event triggered measurement logging may be defined for certain events, such as an out of service event (e.g., when the UE cannot reselect to a cell) and a first event when a camped cell radio quality does not satisfy a threshold. However, such event triggered measurement logging may not be suitable for other types of events. For example, such event triggered measurement logging may not be suitable for determining RAT specific coverage holes and/or for determining frequency specific coverage holes.

In various aspects of techniques and apparatuses described herein, a UE may receive, from a network entity, a logged measurement configuration that defines an event for event triggered measurement logging. The event may be associated with a RAT-specific coverage hole. The RAT-specific coverage hole is an NR coverage hole or an LTE coverage hole. The UE may perform, based at least in part on the logged measurement configuration, measurement logging based at least in part on an occurrence of the event associated with the RAT-specific coverage hole. In some aspects, the UE may perform the measurement logging for a RAT associated with the RAT-specific coverage hole when the UE is camped on the RAT. In some aspects, the UE may perform the measurement logging for a first RAT associated with the RAT-specific coverage hole when the UE is camped on a second RAT. In some aspects, the UE may perform the measurement logging for a RAT associated with the RAT-specific coverage hole irrespective of whether the UE is camped on the RAT or another RAT. As a result, the UE may perform event triggered measurement logging for determining RAT-specific coverage holes, where a RAT-specific coverage hole may be an area in which the UE cannot receive a RAT-specific signal (e.g., an NR signal or an LTE signal) having a power level that satisfies a threshold.

In various aspects of techniques and apparatuses described herein, the logged measurement configuration may define an event for event triggered measurement logging, where the event may be associated with a frequency specific coverage hole. The event associated with the frequency specific coverage hole may occur when a specific frequency does not satisfy a threshold or is absent, or when a measurement on a list of frequencies does not satisfy a threshold or no suitable cell operating on a configured frequency or the list of frequencies is found. The specific frequency associated with the frequency specific coverage hole may be associated with a carrier frequency (e.g., a relatively high carrier frequency or a relatively low carrier frequency). The UE may perform, based at least in part on the logged measurement configuration, measurement logging based at least in part on an occurrence of the event associated with the frequency specific coverage hole. As a result, the UE may perform event triggered measurement logging for determining frequency specific coverage holes, where a frequency specific coverage hole may be an area in which the UE cannot receive a signal at a specific frequency having a power level that satisfies a threshold.

FIG. 3 is a diagram illustrating an example 300 associated with event triggered measurement logging, in accordance with the present disclosure. As shown in FIG. 3, example 300 includes communication between a UE (e.g., UE 120) and a network entity (e.g., base station 110). In some aspects, the UE and the network entity may be included in a wireless network such as wireless network 100.

As shown by reference number 302, the UE may receive, from the network entity, a logged measurement configuration that defines an event for event triggered measurement logging. In some aspects, the event may be associated with a RAT-specific coverage hole. For example, the event may occur based at least in part on an occurrence of a RAT-specific coverage hole, such as an NR coverage hole or an LTE coverage hole. In some aspects, the event may be associated with a frequency specific coverage hole. For example, the event associated with the frequency specific coverage hole may occur when a specific frequency does not satisfy a threshold or is absent. As another example, the event associated with the frequency specific coverage hole may occur when a measurement on a list of frequencies does not satisfy a threshold or no suitable cell operating on a configured frequency or the list of frequencies is found. A “suitable cell” may be a cell associated with a signal level that satisfies a threshold.

As shown by reference number 304, the UE may perform, based at least in part on the logged measurement configuration, measurement logging based at least in part on an occurrence of the event associated with the RAT-specific coverage hole. In some aspects, the UE may perform the measurement logging for a RAT associated with the RAT-specific coverage hole when the UE is camped on the RAT. The RAT-specific coverage hole for the RAT may be configured to be logged when the UE is camped on the same RAT. For example, an NR-specific coverage hole may be configured in an NR logged measurement configuration, or an LTE-specific coverage hole may be configured in an LTE logged measurement configuration. In some aspects, the UE may perform the measurement logging for a first RAT associated with the RAT-specific coverage hole when the UE is camped on a second RAT. The RAT-specific coverage hole for one RAT may be configured to be logged when the UE is camped on another RAT. For example, an NR-specific coverage hole may be configured in an LTE logged measurement configuration, or an LTE-specific coverage hole may be configured in an NR logged measurement configuration. In some aspects, the UE may perform the measurement logging for a RAT associated with the RAT-specific coverage hole irrespective of whether the UE is camped on the RAT or another RAT. The RAT-specific coverage hole for one RAT may be configured to be logged irrespective of a camped cell RAT. For example, an NR-specific coverage hole may be configured in an NR or LTE logged measurement configuration, or an LTE-specific coverage hole may be configured in an NR or LTE logged measurement configuration.

In some aspects, the event associated with the RAT-specific coverage hole may occur when a cell quality does not satisfy a threshold for a serving cell and neighboring cells, and when no RAT-specific suitable cell is available for cell reselection.

In some aspects, the event associated with the RAT-specific coverage hole may be a second event. The logged measurement configuration may extend a first event associated with a camped cell radio quality not satisfying a threshold to incorporate the second event associated with the cell quality not satisfying the threshold for the serving cell and neighboring cells and no RAT-specific suitable cell being available for cell reselection. The first event and the second event are combined to form a single event.

In some aspects, the event associated with the RAT-specific coverage hole may be a second event and an event associated with a camped cell radio quality not satisfying a threshold may be a first event. The UE may perform the measurement logging associated with the second event when the first event does not occur. In some aspects, the event associated with the RAT-specific coverage hole may be a second event and may occur when a first event associated with a camped cell radio quality not satisfying a threshold does not occur.

In some aspects, the event associated with the RAT-specific coverage hole may be a second event, an event associated with a camped cell radio quality not satisfying a threshold may be a first event, and an event associated with the UE being out of service may be an out-of-service event. The UE may perform the measurement logging associated with the second event when the first event and the out-of-service event do not occur.

In some aspects, the event associated with the RAT-specific coverage hole may be a second event that occurs when a serving cell quality satisfies a first threshold while a neighboring cell quality does not satisfy a second threshold and no RAT-specific suitable cell is available for cell reselection.

In some aspects, measurement logging associated with the second event may be terminated when the neighboring cell quality satisfies the second threshold. In some aspects, measurement logging associated with the second event may be terminated based at least in part on an occurrence of another event. In some aspects, measurement logging associated with the second event may not be performed when the UE is camped on a cell associated with a second RAT, where the second RAT may be an LTE RAT. In some aspects, measurement logging associated with the second event may not be performed when the UE is in an any-cell-selection state in which the UE does not reselect to another cell. In some aspects, measurement logging associated with the second event may be performed when the UE is camped on a cell associated with a first RAT, where the first RAT may be an NR RAT.

In some aspects, the UE may perform, based at least in part on the logged measurement configuration, measurement logging based at least in part on an occurrence of the event associated with the frequency specific coverage hole. In some aspects, the UE may perform the measurement logging based at least in part on the occurrence of the event associated with the frequency specific coverage hole irrespective of whether a first event associated with a camped cell radio quality not satisfying a threshold occurs and whether an out-of-service event for the UE occurs. In some aspects, the UE may suspend the measurement logging for configured frequencies when a first event associated with a camped cell radio quality not satisfying a threshold occurs and an out-of-service event for the UE occurs, and the UE may reinitiate the measurement logging for the configured frequencies when the first event and the out-of-service event have ended.

As indicated above, FIG. 3 is provided as an example. Other examples may differ from what is described with regard to FIG. 3.

In some aspects, event triggered measurement logging may be defined for determining RAT specific coverage holes. A second event (eventL2) may be defined for determining the RAT specific coverage holes. The second event may occur when an NR cell quality does not satisfy a threshold (e.g., the NR cell quality goes below a threshold) for serving and neighboring NR cells, and when no suitable NR cell is found in a cell reselection evaluation process.

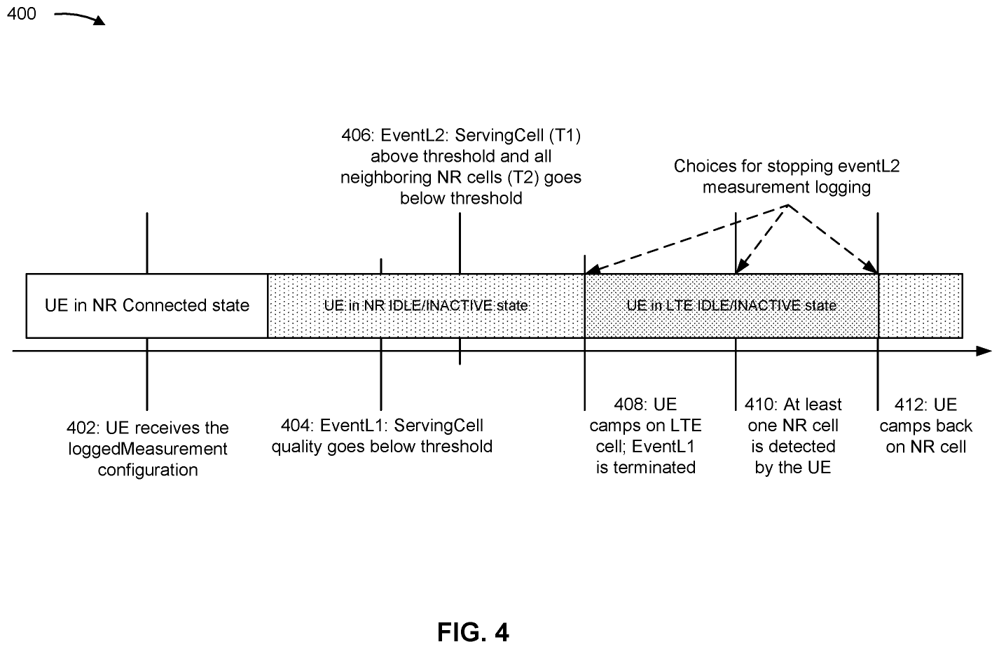

FIG. 4 is a diagram illustrating an example 400 associated with event triggered measurement logging, in accordance with the present disclosure.

As shown by reference number 402, a UE may receive a logged measurement configuration when the UE is in an NR connected state. The UE may enter an NR idle/inactive state. As shown by reference number 404, during the NR idle/inactive state, a first event (EventL1) may occur based at least in part on a serving cell quality not satisfying a threshold (e.g., the serving cell quality may go below a threshold). As shown by reference number 406, during the NR idle/inactive state, a second event (EventL2) may also occur based at least in part on an NR cell quality for a serving cell and a plurality of neighboring NR cells (e.g., all neighboring NR cells) not satisfying a threshold. For example, the NR cell quality for the serving cell and the plurality of neighboring NR cells may fall below a threshold. A first NR cell quality (T1) may correspond to the serving cell and a second NR cell quality (T2) may correspond to the plurality of neighboring NR cells.

As shown by reference number 408, the UE may camp on an LTE cell and enter an LTE idle/inactive state. The first event (EventL1) may be terminated after the UE camps on the LTE cell. As shown by reference number 410, during the LTE idle/inactive state, the UE may detect at least one NR cell having an NR cell quality that satisfies a threshold. As shown by reference number 412, the UE may exit the LTE idle/inactive state and camp back on an NR cell. A measurement logging associated with the second event (EventL2) may be stopped when the UE camps on the LTE cell and enters the LTE idle/inactive state, when the UE detects the at least one NR cell, or when the UE camps back on the NR cell.

In some aspects, while the UE is in the idle/inactive state, the first event (EventL1) may be triggered. While the first event (EventL1) occurs, the second event (EventL2) may also be triggered, and as a result, the UE may move to the LTE idle/inactive state. In this case, the second event (EventL2) may overlap with the first event (EventL1). In some aspects, the first event (EventL1) may be extended to include a period of time while an NR cell quality for a serving cell and a plurality of neighboring NR cells does not satisfy a threshold. In other words, rather than creating the second event (EventL2), the first event (EventL1) may be modified to cover both the first event (EventL1) and the second event (EventL2). In this case, measurement logging associated with the first event (EventL1) may stop when the UE detects at least one NR cell having an NR cell quality that satisfies a threshold.

In some aspects, while the UE is in the idle/inactive state, the first event (EventL1) may be triggered. While the first event (EventL1) occurs, the second event (EventL2) may also be triggered, and as a result, the UE may move to the LTE idle/inactive state. In this case, the second event (EventL2) may overlap with the first event (EventL1). However, having both the first event (EventL1) and the second event (EventL2) running at a same time may be undesirable, as the first event (EventL1) may not be mutually exclusive with the second event (EventL2). In some aspects, to avoid the simultaneous occurrence of the two events, second event (EventL2) measurement logging may be performed when the first event (EventL1) is not met. Although the second event (EventL2) may be met when the NR cell quality for the serving cell and the plurality of neighboring NR cells does not satisfy the threshold, the UE may perform the second event (EventL2) measurement logging after camping on the LTE cell, at which point the first event (EventL1) has been terminated. As a result, the UE does not perform measurement logging for both the first event (EventL1) and the second event (EventL2) simultaneously, which may avoid duplicated measurement logging at the UE.

In some aspects, the UE may start in LTE connected state, move to LTE idle/inactive state, move to NR idle/inactive state, and then move back to the LTE idle/inactive state. In this case, the first event (EventL1) and the second event (EventL2) may be triggered when the UE is in the LTE idle/inactive state.

As indicated above, FIG. 4 is provided as an example. Other examples may differ from what is described with regard to FIG. 4.

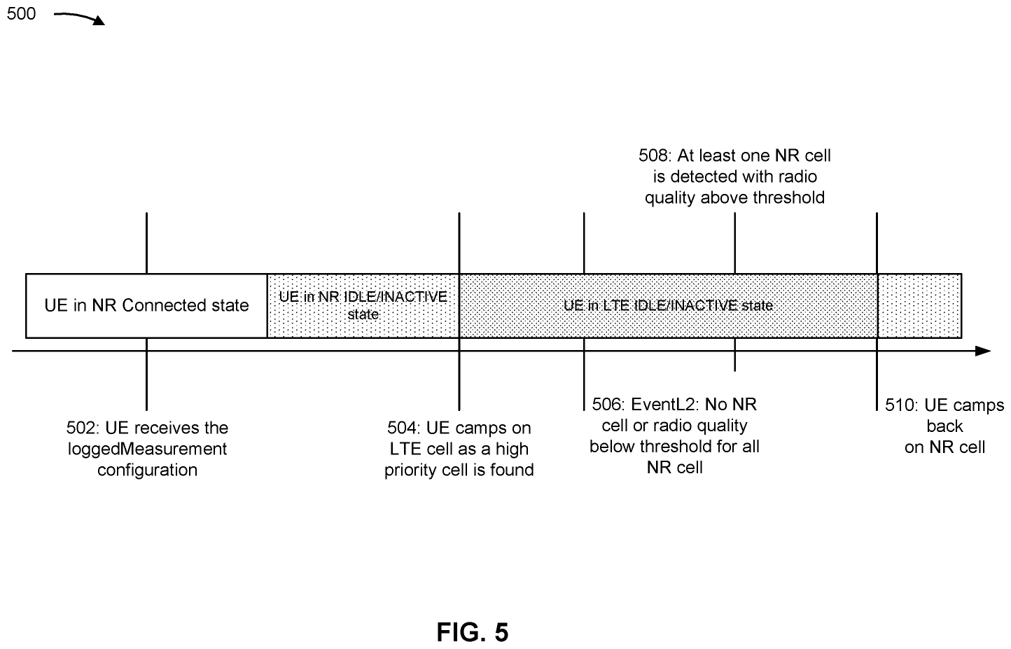

FIG. 5 is a diagram illustrating an example 500 associated with event triggered measurement logging, in accordance with the present disclosure.

As shown by reference number 502, a UE may receive a logged measurement configuration when the UE is in an NR connected state. The UE may enter an NR idle/inactive state. As shown by reference number 504, the UE may detect an LTE cell of high priority and camp on the LTE cell. The UE may enter an LTE idle/inactive state. As shown by reference number 506, during the LTE idle/inactive state, a second event (EventL2) may also occur based at least in part on an NR cell quality for a serving cell and a plurality of neighboring NR cells (e.g., all neighboring NR cells) not satisfying a threshold. For example, the second event (EventL2) may occur when there is no suitable NR cell or NR cells' radio quality is below a threshold. As shown by reference number 508, during the LTE idle/inactive state, the UE may detect at least one NR cell having an NR cell quality that satisfies a threshold (e.g., a radio quality of an NR cell is above a threshold) and may terminate measurement logging for EventL2. As shown by reference number 510, the UE may exit the LTE idle/inactive state and camp back on an NR cell.

In some aspects, the UE may perform a cell reselection to the LTE cell as a result of higher cell prioritization. The UE may camp on the LTE cell when the LTE cell is of a higher priority. In this case, the UE does not camp on the LTE cell based at least in part on a first event (EventL1). When the UE is in the LTE idle/inactive state, the second event (EventL2) may be triggered and the UE may perform measurement logging.

In some aspects, the UE may start in LTE connected state, move to LTE idle/inactive state, move to NR idle/inactive state, and then move back to the LTE idle/inactive state. In this case, the second event (EventL2) may be triggered when the UE is in the NR idle/inactive state.

As indicated above, FIG. 5 is provided as an example. Other examples may differ from what is described with regard to FIG. 5.

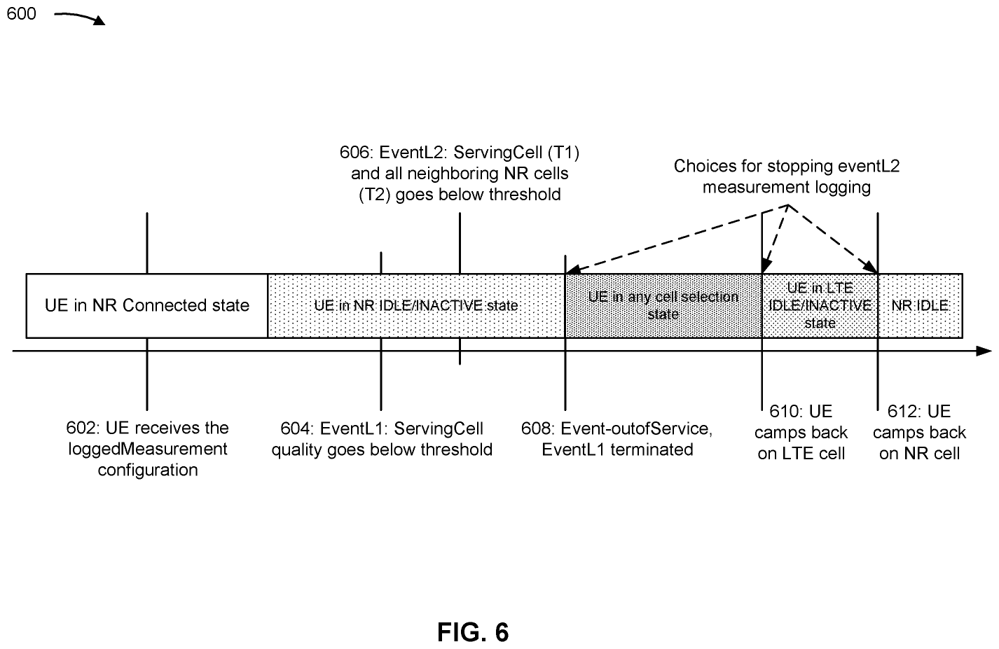

FIG. 6 is a diagram illustrating an example 600 associated with event triggered measurement logging, in accordance with the present disclosure.

As shown by reference number 602, a UE may receive a logged measurement configuration when the UE is in an NR connected state. The UE may enter an NR idle/inactive state. As shown by reference number 604, during the NR idle/inactive state, a first event (EventL1) may occur based at least in part on a serving cell quality not satisfying a threshold (e.g., the serving cell quality may go below a threshold). As shown by reference number 606, during the NR idle/inactive state, a second event (EventL2) may also occur based at least in part on an NR cell quality for a serving cell and a plurality of neighboring NR cells (e.g., all neighboring NR cells) not satisfying a threshold. For example, the NR cell quality for the serving cell and the plurality of neighboring NR cells may fall below a threshold.

As shown by reference number 608, the UE may enter an “any cell selection” state based at least in part on an occurrence of an out-of-service (OutofService) event. The first event (EventL1) may be terminated when the UE enters the “any cell selection” state. During the “any cell selection” state, the UE may not be able to reselect to an NR cell or an LTE cell. As shown by reference number 610, the UE may camp on an LTE cell and enter an LTE idle/inactive state. As shown by reference number 612, the UE may exit the LTE idle/inactive state and camp back on an NR cell. A measurement logging associated with the second event (EventL2) may be stopped when the UE enters the “any cell selection” state, when the UE camps on the LTE cell and enters the LTE idle/inactive state, or when the UE camps back on the NR cell.

In some aspects, while the UE is in the idle/inactive state, the first event (EventL1) may be triggered. While the first event (EventL1) occurs, the second event (EventL2) may also be triggered, and as a result, the UE may move to the LTE idle/inactive state. In this case, the second event (EventL2) may overlap with the first event (EventL1). Further, the UE may exit the NR idle/inactive state and go into an anyCellSelection state and an out-of-service event may be triggered. The UE may go into the anyCellSelection state, which may overlap with the first event (EventL1) and the out-of-service event. In some aspects, to avoid the simultaneous occurrence of the first event (EventL1) and the second event (EventL2), second event (EventL2) measurement logging may be performed when the first event (EventL1) and the out-of-service event are not met. Although the second event (EventL2) may be met when the NR cell quality for the serving cell and the plurality of neighboring NR cells does not satisfy the threshold, the UE may perform the second event (EventL2) measurement logging after camping on the LTE cell, at which point the first event (EventL1) and the out-of-service event have been terminated. As a result, the UE does not perform measurement logging for multiple events simultaneously.

In some aspects, the UE may start in LTE connected state, move to LTE idle/inactive state, move to an any cell selection state, move to an NR cell, and then move back to the LTE idle/inactive state. In this case, the first event (EventL1) and the second event (EventL2) may be triggered when the UE is in the LTE idle/inactive state.

As indicated above, FIG. 6 is provided as an example. Other examples may differ from what is described with regard to FIG. 6.

In some aspects, for determining RAT specific coverage holes, a first event (EventL1) which may occur when a camped cell radio quality does not satisfy a threshold may be extended to occur when an NR cell quality does not satisfy a threshold for serving and neighboring NR cells and when no suitable NR cell is found in a cell reselection evaluation process. Alternatively, for determining RAT specific coverage holes, a second event (EventL2) may be defined to occur when the NR cell quality does not satisfy the threshold for serving and neighboring NR cells and when no suitable NR cell is found in the cell reselection evaluation process. When the second event (EventL2) is defined, the UE may not perform measurement logging based at least in part on the second event (EventL2) until the first event (EventL1) is not met.

In some aspects, a second event (eventL2) may be defined for determining RAT specific coverage holes. The second event (eventL2) may occur when an NR serving cell quality satisfies a threshold (e.g., the NR serving cell quality is above a certain threshold) while an NR neighboring cell quality does not satisfy a threshold (e.g., the NR neighboring cell quality goes below a certain threshold), and when no other suitable NR cell is available for cell reselection.

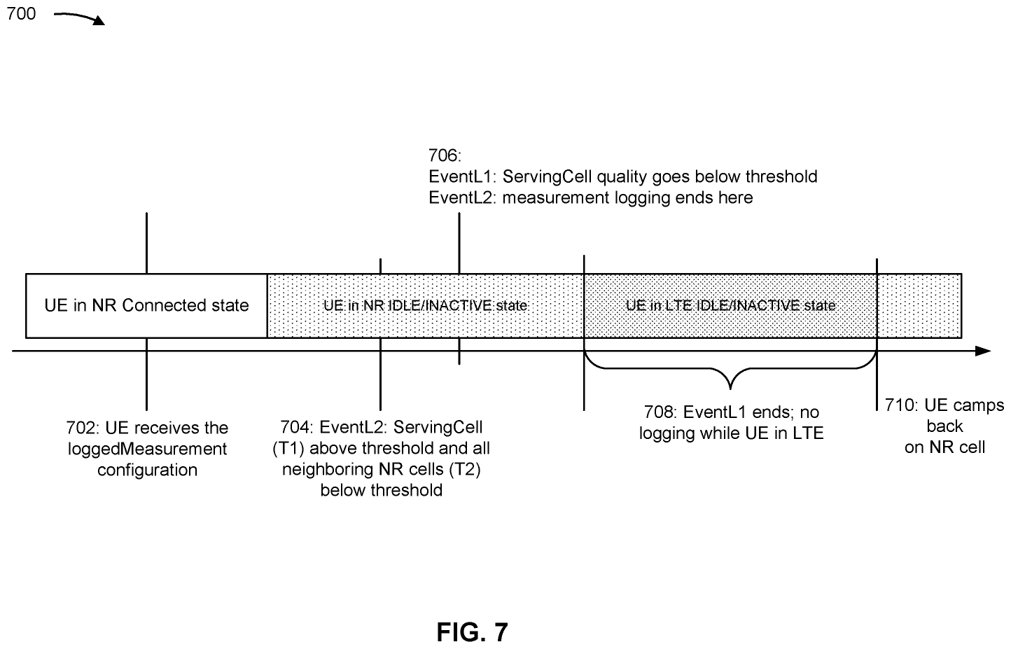

FIG. 7 is a diagram illustrating an example 700 associated with event triggered measurement logging, in accordance with the present disclosure.

As shown by reference number 702, a UE may receive a logged measurement configuration when the UE is in an NR connected state. The UE may enter an NR idle/inactive state. As shown by reference number 704, during the NR idle/inactive state, a second event (EventL2) may occur based at least in part on an NR cell quality for a serving cell satisfying a threshold (e.g., the NR cell quality is above a threshold) and an NR cell quality for a plurality of neighboring NR cells does not satisfy a threshold (e.g., the NR cell quality for all neighboring NR cells is below a threshold).

As shown by reference number 706, during the NR idle/inactive state, a first event (EventL1) may occur based at least in part on a serving cell quality not satisfying a threshold (e.g., the serving cell quality may go below a threshold), and a measurement logging associated with the second event (EventL2) may end. The UE may exit the NR idle/inactive state and enter an LTE idle/inactive state. As shown by reference number 708, the first event (EventL1) may end and no measurement logging may occur when the UE is in the LTE idle/inactive state. As shown by reference number 710, the UE may exit the LTE idle/inactive state and camp back on an NR cell.

In some aspects, measurement logging for the second event (EventL2) may be terminated when a neighboring cell quality satisfies a threshold, or based at least in part on a detection of another event, such as the first event (EventL1). In some aspects, the UE may not perform measurement logging for the second event (EventL2) when the UE is camped on an LTE cell or in an “any cell selection” state. In some aspects, the UE may perform measurement logging when the second event (EventL2) is met when camped on an NR cell.

In some aspects, the UE may start in LTE connected state, move to LTE idle/inactive state, move to NR idle/inactive state, and then move back to the LTE idle/inactive state. In this case, the second event (EventL2) and the first event (EventL1) may be triggered when the UE is in the LTE idle/inactive state.

As indicated above, FIG. 7 is provided as an example. Other examples may differ from what is described with regard to FIG. 7.

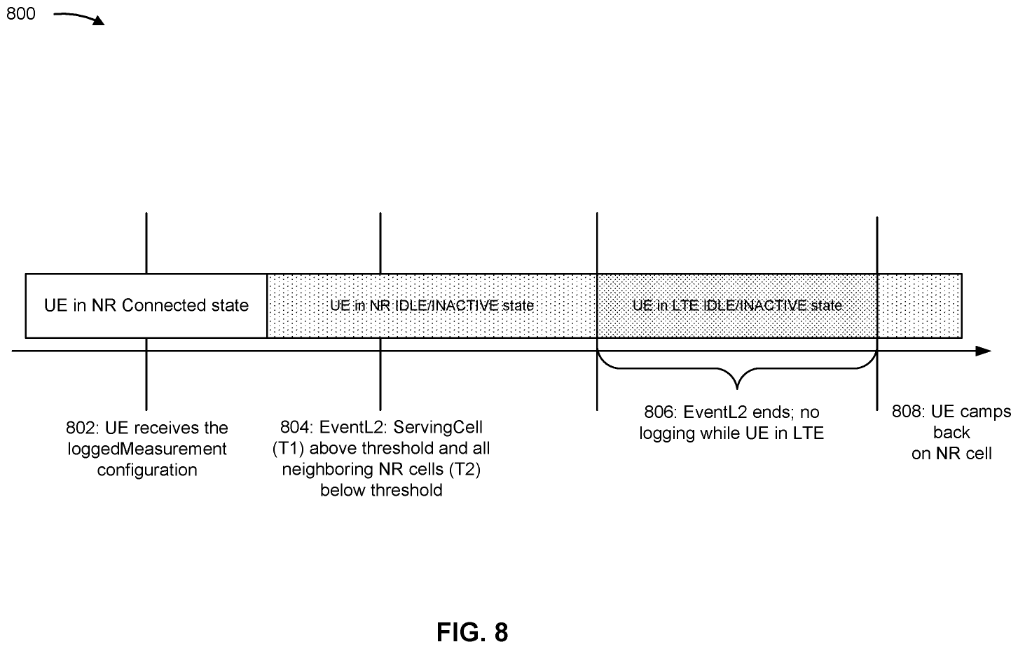

FIG. 8 is a diagram illustrating an example 800 associated with event triggered measurement logging, in accordance with the present disclosure.

As shown by reference number 802, a UE may receive a logged measurement configuration when the UE is in an NR connected state. The UE may enter an NR idle/inactive state. As shown by reference number 804, during the NR idle/inactive state, a second event (EventL2) may occur based at least in part on an NR cell quality for a serving cell satisfying a threshold (e.g., the NR cell quality is above a threshold) and an NR cell quality for a plurality of neighboring NR cells does not satisfy a threshold (e.g., the NR cell quality for all neighboring NR cells is below a threshold). The UE may exit the NR idle/inactive state and enter an LTE idle/inactive state. As shown by reference number 806, the second event (EventL2) may end and no measurement logging may occur when the UE is in the LTE idle/inactive state. As shown by reference number 808, the UE may exit the LTE idle/inactive state and camp back on an NR cell having an NR cell quality that satisfies a threshold.

In some aspects, the UE may start in LTE connected state, move to LTE idle/inactive state, move to NR idle/inactive state, and then move back to the LTE idle/inactive state. In this case, the second event (EventL2) may be triggered when the UE is in the LTE idle/inactive state.

As indicated above, FIG. 8 is provided as an example. Other examples may differ from what is described with regard to FIG. 8.

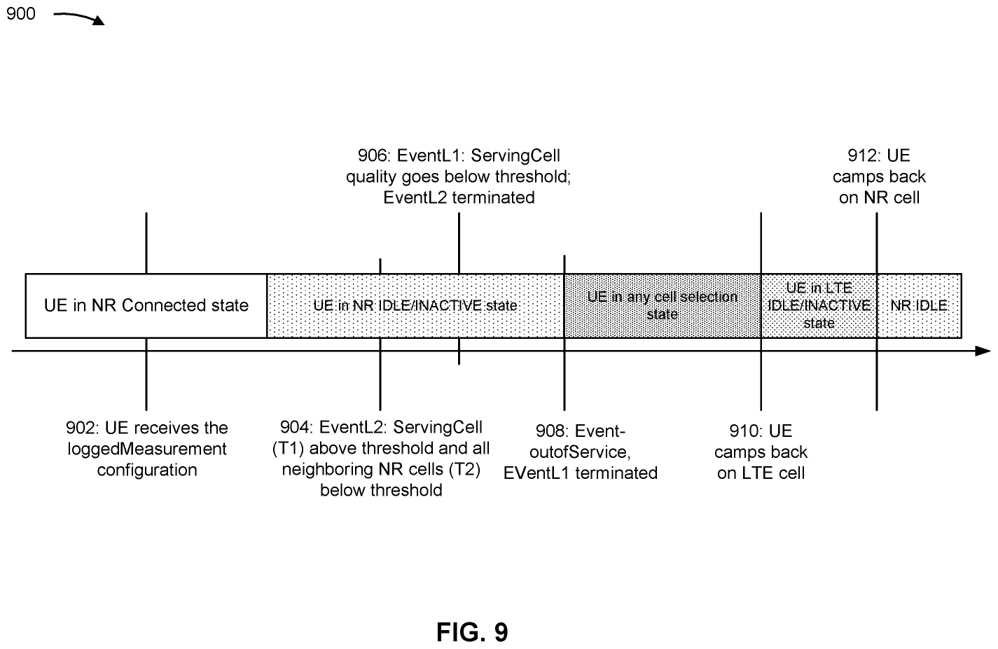

FIG. 9 is a diagram illustrating an example 900 associated with event triggered measurement logging, in accordance with the present disclosure.

As shown by reference number 902, a UE may receive a logged measurement configuration when the UE is in an NR connected state. The UE may enter an NR idle/inactive state. As shown by reference number 904, during the NR idle/inactive state, a second event (EventL2) may occur based at least in part on an NR cell quality for a serving cell satisfying a threshold (e.g., the NR cell quality is above a threshold) and an NR cell quality for a plurality of neighboring NR cells does not satisfy a threshold (e.g., the NR cell quality for all neighboring NR cells is below a threshold). As shown by reference number 906, during the NR idle/inactive state, a first event (EventL1) may also occur based at least in part on a serving cell quality not satisfying a threshold (e.g., the serving cell quality may go below a threshold), and the second event (EventL2) may be terminated.

As shown by reference number 908, the UE may enter an “any cell selection” state based at least in part on an occurrence of an out-of-service (OutofService) event. The first event (EventL1) may be terminated when the UE enters the “any cell selection” state. During the “any cell selection” state, the UE may not be able to reselect to an NR cell or an LTE cell. As shown by reference number 910, the UE may camp on an LTE cell and enter an LTE idle/inactive state. As shown by reference number 912, the UE may exit the LTE idle/inactive state and camp back on an NR cell having an NR cell quality that satisfies a threshold.

In some aspects, the UE may start in LTE connected state, move to LTE idle/inactive state, move to an any cell selection state, move to an NR cell, and then move back to the LTE idle/inactive state. In this case, the second event (EventL2) and the first event (EventL1) may be triggered when the UE is in the LTE idle/inactive state.

As indicated above, FIG. 9 is provided as an example. Other examples may differ from what is described with regard to FIG. 9.

In some aspects, event triggered measurement logging may be defined for determining frequency specific coverage holes. The UE may perform frequency based logging independent of whether the UE is in a camped state (e.g., whether the UE is camped on an NR cell or an LTE cell) or independent of whether the UE is in an “any cell selection” state. A network entity may configure the UE to perform measurement logging when a specific frequency is below a threshold or absent or when a measurement on a list of frequencies is below a threshold or absent. In other words, the event to perform the measurement logging may be triggered when a specific frequency is below a threshold or absent or when a measurement on a list of frequencies is below a threshold or absent. In some aspects, the UE may allow duplication when performing the measurement logging. For example, the UE may keep monitoring and logging measurements irrespective of whether a first event (eventL1) or an out-of-service event are met or not met. In some aspects, the UE may avoid duplication when performing the measurement logging. For example, the UE may suspend monitoring and logging of configured frequencies when the first event (eventL1) and the out-of-service event are met. The UE may reinitiate the monitoring after the UE comes back from the first event (eventL1) and the out-of-service event.

FIG. 10 is a diagram illustrating an example process 1000 performed, for example, by a UE, in accordance with the present disclosure. Example process 1000 is an example where the UE (e.g., UE 120) performs operations associated with event triggered measurement logging.

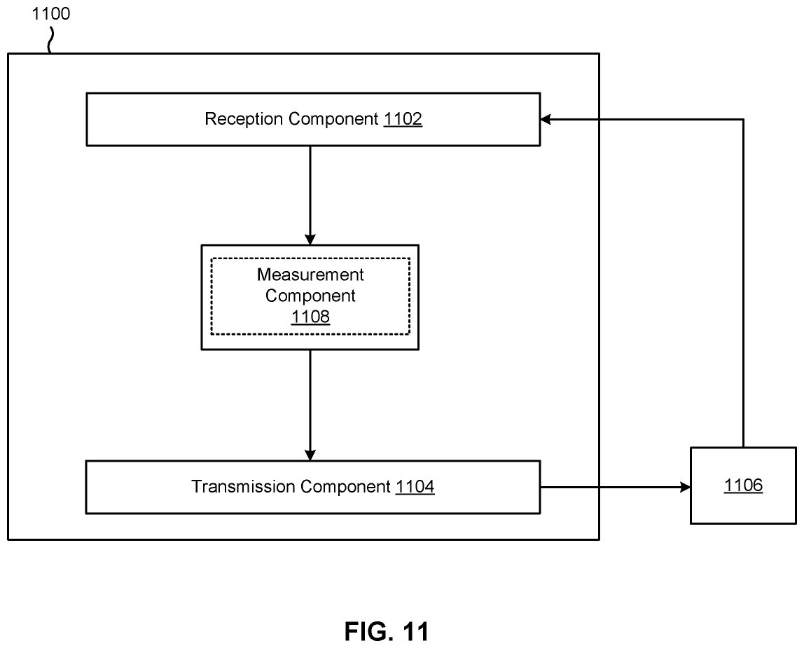

As shown in FIG. 10, in some aspects, process 1000 may include receiving, from a network entity, a logged measurement configuration that defines an event for event triggered measurement logging, wherein the event is associated with a RAT-specific coverage hole or a frequency specific coverage hole (block 1010). For example, the UE (e.g., using reception component 1102, depicted in FIG. 11) may receive, from a network entity, a logged measurement configuration that defines an event for event triggered measurement logging, wherein the event is associated with a RAT-specific coverage hole or a frequency specific coverage hole, as described above.

As further shown in FIG. 10, in some aspects, process 1000 may include performing, based at least in part on the logged measurement configuration, measurement logging based at least in part on an occurrence of the event associated with the RAT-specific coverage hole or the frequency specific coverage hole (block 1020). For example, the UE (e.g., using measurement component 1108, depicted in FIG. 11) may perform, based at least in part on the logged measurement configuration, measurement logging based at least in part on an occurrence of the event associated with the RAT-specific coverage hole or the frequency specific coverage hole, as described above.

Process 1000 may include additional aspects, such as any single aspect or any combination of aspects described below and/or in connection with one or more other processes described elsewhere herein.

In a first aspect, the RAT-specific coverage hole is a New Radio coverage hole or a Long Term Evolution coverage hole.

In a second aspect, alone or in combination with the first aspect, performing the measurement logging comprises performing the measurement logging for a RAT associated with the RAT-specific coverage hole when the UE is camped on the RAT.

In a third aspect, alone or in combination with one or more of the first and second aspects, performing the measurement logging comprises performing the measurement logging for a first RAT associated with the RAT-specific coverage hole when the UE is camped on a second RAT.

In a fourth aspect, alone or in combination with one or more of the first through third aspects, performing the measurement logging comprises performing the measurement logging for a RAT associated with the RAT-specific coverage hole irrespective of whether the UE is camped on the RAT or another RAT.

In a fifth aspect, alone or in combination with the fourth aspect, the event associated with the RAT-specific coverage hole occurs when a cell quality does not satisfy a threshold for a serving cell and neighboring cells and when no RAT-specific suitable cell is available for cell reselection.

In a sixth aspect, alone or in combination with one or more of the first and fifth aspects, the event associated with the RAT-specific coverage hole is a second event, wherein the logged measurement configuration extends a first event associated with a camped cell radio quality not satisfying a threshold to incorporate the second event associated with the cell quality not satisfying the threshold for the serving cell and neighboring cells and no RAT-specific suitable cell being available for cell reselection, and wherein the first event and the second event are combined to form a single event.

In a seventh aspect, alone or in combination with one or more of the first through sixth aspects, the event associated with the RAT-specific coverage hole is a second event and an event associated with a camped cell radio quality not satisfying a threshold is a first event, and performing the measurement logging comprises performing the measurement logging associated with the second event when the first event does not occur.

In an eighth aspect, alone or in combination with one or more of the first through seventh aspects, the event associated with the RAT-specific coverage hole is a second event and occurs when a first event associated with a camped cell radio quality not satisfying a threshold does not occur.

In a ninth aspect, alone or in combination with one or more of the first through eighth aspects, the event associated with the RAT-specific coverage hole is a second event, an event associated with a camped cell radio quality not satisfying a threshold is a first event, and an event associated with the UE being out of service is an out-of-service event, and performing the measurement logging comprises performing the measurement logging associated with the second event when the first event and the out-of-service event do not occur.

In a tenth aspect, alone or in combination with one or more of the first through ninth aspects, the event associated with the RAT-specific coverage hole is a second event that occurs when a serving cell quality satisfies a first threshold while a neighboring cell quality does not satisfy a second threshold and no RAT-specific suitable cell is available for cell reselection.

In an eleventh aspect, alone or in combination with one or more of the first through tenth aspects, measurement logging associated with the second event is terminated when the neighboring cell quality satisfies the second threshold.

In a twelfth aspect, alone or in combination with one or more of the first through eleventh aspects, measurement logging associated with the second event is terminated based at least in part on an occurrence of another event.

In a thirteenth aspect, alone or in combination with one or more of the first through twelfth aspects, measurement logging associated with the second event is not performed when the UE is camped on a cell associated with a second RAT, wherein the second RAT is a Long Term Evolution RAT.

In a fourteenth aspect, alone or in combination with one or more of the first through thirteenth aspects, measurement logging associated with the second event is not performed when the UE is in an any-cell-selection state in which the UE does not reselect to another cell.

In a fifteenth aspect, alone or in combination with one or more of the first through fourteenth aspects, measurement logging associated with the second event is performed when the UE is camped on a cell associated with a first RAT, wherein the first RAT is a New Radio RAT.

In a sixteenth aspect, alone or in combination with one or more of the first through fifteenth aspects, the event associated with the frequency specific coverage hole occurs when a specific frequency does not satisfy a threshold or is absent.

In a seventeenth aspect, alone or in combination with one or more of the first through sixteenth aspects, the event associated with the frequency specific coverage hole occurs when a measurement on a list of frequencies does not satisfy a threshold or no suitable cell operating on a configured frequency or the list of frequencies is found.

In an eighteenth aspect, alone or in combination with one or more of the first through seventeenth aspects, performing the measurement logging comprises performing the measurement logging based at least in part on an occurrence of the event associated with the frequency specific coverage hole irrespective of whether a first event associated with a camped cell radio quality not satisfying a threshold occurs and whether an out-of-service event for the UE occurs.

In a nineteenth aspect, alone or in combination with one or more of the first through eighteenth aspects, performing the measurement logging based at least in part on an occurrence of the event associated with the frequency specific coverage hole comprises suspending the measurement logging for configured frequencies when a first event associated with a camped cell radio quality not satisfying a threshold occurs and an out-of-service event for the UE occurs, and reinitiating the measurement logging for the configured frequencies when the first event and the out-of-service event have ended.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a block diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a measurement component 1108, among other examples.

In some aspects, the apparatus 1100 may be configured to perform one or more operations described herein in connection with FIGS. 3-9. Additionally, or alternatively, the apparatus 1100 may be configured to perform one or more processes described herein, such as process 1000 of FIG. 10. In some aspects, the apparatus 1100 and/or one or more components shown in FIG. 11 may include one or more components of the UE described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a demodulator, a MIMO detector, a receive processor, a controller/processor, a memory, or a combination thereof, of the UE described above in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the UE described above in connection with FIG. 2. In some aspects, the transmission component 1104 may be co-located with the reception component 1102 in a transceiver.

The reception component 1102 may receive, from a network entity, a logged measurement configuration that defines an event for event triggered measurement logging, wherein the event is associated with a RAT-specific coverage hole or a frequency specific coverage hole. The measurement component 1108 may perform, based at least in part on the logged measurement configuration, measurement logging based at least in part on an occurrence of the event associated with the RAT-specific coverage hole or the frequency specific coverage hole.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, from a network entity, a logged measurement configuration that defines an event for event triggered measurement logging, wherein the event is associated with a radio access technology (RAT)-specific coverage hole or a frequency specific coverage hole; and performing, based at least in part on the logged measurement configuration, measurement logging based at least in part on an occurrence of the event associated with the RAT-specific coverage hole or the frequency specific coverage hole.

Aspect 2: The method of Aspect 1, wherein the RAT-specific coverage hole is a New Radio coverage hole or a Long Term Evolution coverage hole.

Aspect 3: The method of any of Aspects 1 through 2, wherein performing the measurement logging comprises performing the measurement logging for a RAT associated with the RAT-specific coverage hole when the UE is camped on the RAT.

Aspect 4: The method of any of Aspects 1 through 3, wherein performing the measurement logging comprises performing the measurement logging for a first RAT associated with the RAT-specific coverage hole when the UE is camped on a second RAT.

Aspect 5: The method of any of Aspects 1 through 4, wherein performing the measurement logging comprises performing the measurement logging for a RAT associated with the RAT-specific coverage hole irrespective of whether the UE is camped on the RAT or another RAT.

Aspect 6: The method of any of Aspects 1 through 5, wherein the event associated with the RAT-specific coverage hole occurs when a cell quality does not satisfy a threshold for a serving cell and neighboring cells and when no RAT-specific suitable cell is available for cell reselection.

Aspect 7: The method of Aspect 6, wherein the event associated with the RAT-specific coverage hole is a second event, and wherein the logged measurement configuration extends a first event associated with a camped cell radio quality not satisfying a threshold to incorporate the second event associated with the cell quality not satisfying the threshold for the serving cell and neighboring cells and no RAT-specific suitable cell being available for cell reselection, and wherein the first event and the second event are combined to form a single event.

Aspect 8: The method of Aspect 6, wherein the event associated with the RAT-specific coverage hole is a second event and an event associated with a camped cell radio quality not satisfying a threshold is a first event, and wherein performing the measurement logging comprises performing the measurement logging associated with the second event when the first event does not occur.

Aspect 9: The method of Aspect 6, wherein the event associated with the RAT-specific coverage hole is a second event and occurs when a first event associated with a camped cell radio quality not satisfying a threshold does not occur.

Aspect 10: The method of Aspect 6, wherein the event associated with the RAT-specific coverage hole is a second event, an event associated with a camped cell radio quality not satisfying a threshold is a first event, and an event associated with the UE being out of service is an out-of-service event, and wherein performing the measurement logging comprises performing the measurement logging associated with the second event when the first event and the out-of-service event do not occur.

Aspect 11: The method of any of Aspects 1 through 10, wherein the event associated with the RAT-specific coverage hole is a second event that occurs when a serving cell quality satisfies a first threshold while a neighboring cell quality does not satisfy a second threshold and no RAT-specific suitable cell is available for cell reselection.

Aspect 12: The method of Aspect 11, wherein measurement logging associated with the second event is terminated when the neighboring cell quality satisfies the second threshold.

Aspect 13: The method of Aspect 11, wherein measurement logging associated with the second event is terminated based at least in part on an occurrence of another event.

Aspect 14: The method of Aspect 11, wherein measurement logging associated with the second event is not performed when the UE is camped on a cell associated with a second RAT, wherein the second RAT is a Long Term Evolution RAT.

Aspect 15: The method of Aspect 11, wherein measurement logging associated with the second event is not performed when the UE is in an any-cell-selection state in which the UE does not reselect to another cell.

Aspect 16: The method of Aspect 11, wherein measurement logging associated with the second event is performed when the UE is camped on a cell associated with a first RAT, wherein the first RAT is a New Radio RAT.

Aspect 17: The method of any of Aspects 1 through 16, wherein the event associated with the frequency specific coverage hole occurs when a specific frequency does not satisfy a threshold or is absent.

Aspect 18: The method of any of Aspects 1 through 17, wherein the event associated with the frequency specific coverage hole occurs when a measurement on a list of frequencies does not satisfy a threshold or no suitable cell operating on a configured frequency or the list of frequencies is found.

Aspect 19: The method of any of Aspects 1 through 18, wherein performing the measurement logging comprises performing the measurement logging based at least in part on an occurrence of the event associated with the frequency specific coverage hole irrespective of whether a first event associated with a camped cell radio quality not satisfying a threshold occurs and whether an out-of-service event for the UE occurs.

Aspect 20: The method of any of Aspects 1 through 19, wherein performing the measurement logging based at least in part on an occurrence of the event associated with the frequency specific coverage hole comprises: suspending the measurement logging for configured frequencies when a first event associated with a camped cell radio quality not satisfying a threshold occurs and an out-of-service event for the UE occurs; and reinitiating the measurement logging for the configured frequencies when the first event and the out-of-service event have ended.

Aspect 21: An apparatus for wireless communication at a device, comprising a processor; memory coupled with the processor; and instructions stored in the memory and executable by the processor to cause the apparatus to perform the method of one or more Aspects of Aspects 1-20.

Aspect 22: A device for wireless communication, comprising a memory and one or more processors coupled to the memory, the one or more processors configured to perform the method of one or more Aspects of Aspects 1-20.

Aspect 23: An apparatus for wireless communication, comprising at least one means for performing the method of one or more Aspects of Aspects 1-20.

Aspect 24: A non-transitory computer-readable medium storing code for wireless communication, the code comprising instructions executable by a processor to perform the method of one or more Aspects of Aspects 1-20.

Aspect 25: A non-transitory computer-readable medium storing a set of instructions for wireless communication, the set of instructions comprising one or more instructions that, when executed by one or more processors of a device, cause the device to perform the method of one or more Aspects of Aspects 1-20.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE) for wireless communication, comprising:
a memory; and
one or more processors, coupled to the memory, configured to:
receive, from a network entity, a logged measurement configuration that defines an event for event triggered measurement logging, wherein the event is associated with a radio access technology (RAT)-specific coverage hole or a frequency specific coverage hole; and
perform, based at least in part on the logged measurement configuration, measurement logging based at least in part on an occurrence of the event associated with the RAT-specific coverage hole or the frequency specific coverage hole.

2. The apparatus of claim 1, wherein the RAT-specific coverage hole is a New Radio coverage hole or a Long Term Evolution coverage hole.

3. The apparatus of claim 1, wherein the one or more processors, to perform the measurement logging, are configured to:
perform the measurement logging for a RAT associated with the RAT-specific coverage hole when the UE is camped on the RAT;
perform the measurement logging for a first RAT associated with the RAT-specific coverage hole when the UE is camped on a second RAT; or
perform the measurement logging for the RAT associated with the RAT-specific coverage hole irrespective of whether the UE is camped on the RAT or another RAT.

4. The apparatus of claim 1, wherein the event associated with the RAT-specific coverage hole occurs when a cell quality does not satisfy a threshold for a serving cell and neighboring cells and when no RAT-specific suitable cell is available for cell reselection.

5. The apparatus of claim 4, wherein the event associated with the RAT-specific coverage hole is a second event, and wherein the logged measurement configuration extends a first event associated with a camped cell radio quality not satisfying a threshold to incorporate the second event associated with the cell quality not satisfying the threshold for the serving cell and neighboring cells and no RAT-specific suitable being available for cell reselection, and wherein the first event and the second event are combined to form a single event.

6. The apparatus of claim 4, wherein the event associated with the RAT-specific coverage hole is a second event and an event associated with a camped cell radio quality not satisfying a threshold is a first event, and wherein measurement logging associated with the second event is performed when the first event does not occur.

7. The apparatus of claim 4, wherein the event associated with the RAT-specific coverage hole is a second event and occurs when a first event associated with a camped cell radio quality not satisfying a threshold does not occur.

8. The apparatus of claim 4, wherein the event associated with the RAT-specific coverage hole is a second event, an event associated with a camped cell radio quality not satisfying a threshold is a first event, and an event associated with the UE being out of service is an out-of-service event, and wherein measurement logging associated with the second event is performed when the first event and the out-of-service event do not occur.

9. The apparatus of claim 1, wherein the event associated with the RAT-specific coverage hole is a second event that occurs when a serving cell quality satisfies a first threshold while a neighboring cell quality does not satisfy a second threshold and no RAT-specific suitable cell is available for cell reselection.

10. The apparatus of claim 9, wherein:
measurement logging associated with the second event is terminated when the neighboring cell quality satisfies the second threshold;
measurement logging associated with the second event is terminated based at least in part on an occurrence of another event; or
measurement logging associated with the second event is not performed when the UE is camped on a cell associated with a second RAT, wherein the second RAT is a Long Term Evolution RAT.

11. The apparatus of claim 9, wherein:
measurement logging associated with the second event is not performed when the UE is in an any-cell-selection state in which the UE does not reselect to another cell; or
measurement logging associated with the second event is performed when the UE is camped on a cell associated with a first RAT, wherein the first RAT is a New Radio RAT.

12. The apparatus of claim 1, wherein:
the event associated with the frequency specific coverage hole occurs when a specific frequency does not satisfy a threshold or is absent; or
the event associated with the frequency specific coverage hole occurs when a measurement on a list of frequencies does not satisfy a threshold or no suitable cell operating on a configured frequency or the list of frequencies is found.

13. The apparatus of claim 1, wherein the one or more processors, to perform the measurement logging, are configured to perform the measurement logging based at least in part on an occurrence of the event associated with the frequency specific coverage hole irrespective of whether a first event associated with a camped cell radio quality not satisfying a threshold occurs and whether an out-of-service event for the UE occurs.

14. The apparatus of claim 1, wherein the one or more processors, to perform the measurement logging based at least in part on an occurrence of the event associated with the frequency specific coverage hole, are configured to:
suspend the measurement logging for configured frequencies when a first event associated with a camped cell radio quality not satisfying a threshold occurs and an out-of-service event for the UE occurs; and
reinitiate the measurement logging for the configured frequencies when the first event and the out-of-service event have ended.

15. A method of wireless communication performed by a user equipment (UE), comprising:
receiving, from a network entity, a logged measurement configuration that defines an event for event triggered measurement logging, wherein the event is associated with a radio access technology (RAT)-specific coverage hole or a frequency specific coverage hole; and
performing, based at least in part on the logged measurement configuration, measurement logging based at least in part on an occurrence of the event associated with the RAT-specific coverage hole or the frequency specific coverage hole.

16. The method of claim 15, wherein the RAT-specific coverage hole is a New Radio coverage hole or a Long Term Evolution coverage hole.

17. The method of claim 15, wherein performing the measurement logging comprises:
performing the measurement logging for a RAT associated with the RAT-specific coverage hole when the UE is camped on the RAT;
performing the measurement logging for a first RAT associated with the RAT-specific coverage hole when the UE is camped on a second RAT; or
performing the measurement logging for the RAT associated with the RAT-specific coverage hole irrespective of whether the UE is camped on the RAT or another RAT.

18. The method of claim 15, wherein the event associated with the RAT-specific coverage hole occurs when a cell quality does not satisfy a threshold for a serving cell and neighboring cells and when no RAT-specific suitable cell is available for cell reselection.

19. The method of claim 18, wherein the event associated with the RAT-specific coverage hole is a second event, and wherein the logged measurement configuration extends a first event associated with a camped cell radio quality not satisfying a threshold to incorporate the second event associated with the cell quality not satisfying the threshold for the serving cell and neighboring cells and no RAT-specific suitable cell being available for cell reselection, and wherein the first event and the second event are combined to form a single event.

20. The method of claim 18, wherein the event associated with the RAT-specific coverage hole is a second event and an event associated with a camped cell radio quality not satisfying a threshold is a first event, and wherein performing the measurement logging comprises performing the measurement logging associated with the second event when the first event does not occur.

21. The method of claim 18, wherein the event associated with the RAT-specific coverage hole is a second event and occurs when a first event associated with a camped cell radio quality not satisfying a threshold does not occur.

22. The method of claim 18, wherein the event associated with the RAT-specific coverage hole is a second event, an event associated with a camped cell radio quality not satisfying a threshold is a first event, and an event associated with the UE being out of service is an out-of-service event, and wherein performing the measurement logging comprises performing the measurement logging associated with the second event when the first event and the out-of-service event do not occur.

23. The method of claim 15, wherein the event associated with the RAT-specific coverage hole is a second event that occurs when a serving cell quality satisfies a first threshold while a neighboring cell quality does not satisfy a second threshold and no RAT-specific suitable cell is available for cell reselection.

24. The method of claim 23, wherein:
measurement logging associated with the second event is terminated when the neighboring cell quality satisfies the second threshold;
measurement logging associated with the second event is terminated based at least in part on an occurrence of another event; or
measurement logging associated with the second event is not performed when the UE is camped on a cell associated with a second RAT, wherein the second RAT is a Long Term Evolution RAT.

25. The method of claim 23, wherein:
measurement logging associated with the second event is not performed when the UE is in an any-cell-selection state in which the UE does not reselect to another cell; or
measurement logging associated with the second event is performed when the UE is camped on a cell associated with a first RAT, wherein the first RAT is a New Radio RAT.

26. The method of claim 15, wherein:
the event associated with the frequency specific coverage hole occurs when a specific frequency does not satisfy a threshold or is absent; or
the event associated with the frequency specific coverage hole occurs when a measurement on a list of frequencies does not satisfy a threshold or no suitable cell operating on a configured frequency or the list of frequencies is found.

27. The method of claim 15, wherein performing the measurement logging comprises performing the measurement logging based at least in part on an occurrence of the event associated with the frequency specific coverage hole irrespective of whether a first event associated with a camped cell radio quality not satisfying a threshold occurs and whether an out-of-service event for the UE occurs.

28. The method of claim 15, wherein performing the measurement logging based at least in part on an occurrence of the event associated with the frequency specific coverage hole comprises:
suspending the measurement logging for configured frequencies when a first event associated with a camped cell radio quality not satisfying a threshold occurs and an out-of-service event for the UE occurs; and
reinitiating the measurement logging for the configured frequencies when the first event and the out-of-service event have ended.

29. A non-transitory computer-readable medium storing a set of instructions for wireless communication, the set of instructions comprising:
one or more instructions that, when executed by one or more processors of a user equipment (UE), cause the UE to:
receive, from a network entity, a logged measurement configuration that defines an event for event triggered measurement logging, wherein the event is associated with a radio access technology (RAT)-specific coverage hole or a frequency specific coverage hole; and
perform, based at least in part on the logged measurement configuration, measurement logging based at least in part on an occurrence of the event associated with the RAT-specific coverage hole or the frequency specific coverage hole.

30. An apparatus for wireless communication, comprising:
means for receiving, from a network entity, a logged measurement configuration that defines an event for event triggered measurement logging, wherein the event is associated with a radio access technology (RAT)-specific coverage hole or a frequency specific coverage hole; and
means for performing, based at least in part on the logged measurement configuration, measurement logging based at least in part on an occurrence of the event associated with the RAT-specific coverage hole or the frequency specific coverage hole.
